(19) United States
(12) Patent Application Publication
(10) Pub. No.: US 2024/0333029 A1
(43) Pub. Date: Oct. 3, 2024

(54) MULTI-LEVEL ENERGY CONFIGURATION FOR ENERGY HARVESTING WIRELESS DEVICES

(71) Applicant: Telefonaktiebolaget LM Ericsson (publ), Stockholm (SE)

(72) Inventors: Zhilan XIONG, Solna (SE); Mohammad MOZAFFARI, Fremont, CA (US); Stefan WÄNSTEDT, Luleå (SE); Sina MALEKI, Malmö (SE); Andreas HÖGLUND, Solna (SE); Paul SCHLIWA-BERTLING, Ljungsbro (SE)

(21) Appl. No.: 18/293,464

(22) PCT Filed: Aug. 12, 2022
(86) PCT No.: PCT/EP2022/072695

§ 371 Date: Jan. 30, 2024

Related U.S. Application Data
(60) Provisional application No. 63/232,842, filed on Aug. 13, 2021.

(51) Int. Cl. H02J 50/00; H02J 50/80; H04L 1/00; H04W 28/02

(52) U.S. Cl. CPC H02J 50/001; H02J 50/80; H04L 1/0018; H04L 1/0021; H04W 28/0268

(57) ABSTRACT

A method, system and apparatus are disclosed. According to one or more embodiments, an energy harvesting wireless device configured to communicate with a network node is provided. The energy harvesting wireless device includes processing circuitry configured to determine a first energy level of the energy harvesting wireless device meets a first threshold of a set of multi-level energy thresholds, and send to the network node a reporting indicating one of an enablement and disablement of a first communication configuration for a data flow of an application service based on the determination that the first threshold is met.

### TECHNICAL FIELD

The present disclosure relates to wireless communications, and in particular, to multi-level energy configuration for wireless devices that, for example, rely on harvested energy.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

The next paradigm shift in processing and manufacturing is the Industry 4.0 initiative in which factories are automated and made much more flexible and dynamic with the help of wireless connectivity. This includes real-time control of robots and machines using time-critical machine-type communication (cMTC) and improved observability, control, and error detection with the help of large numbers of more simple actuators and sensors (massive machine-type communication or mMTC). For cMTC support, URLLC (ultra-reliable low-latency communication) was introduced in 3GPP Release 15 for both LTE (Long-Term Evolution) and NR (New Radio), and NR URLLC is further enhanced in 3GPP Release 16 within the enhanced URLLC (EURLLC) and Industrial internet of things (IoT) work items.

For mMTC and low power wide area (LPWA) support, 3GPP introduced both Narrowband Internet-of-Things (NB-IoT) and Long-Term Evolution for Machine-Type Communications (LTE-MTC, or LTE-M) in 3GPP Release 13. These technologies have been further enhanced through all releases up until and including the ongoing 3GPP Release 17 work. NR was introduced in 3GPP Release 15 and focused at least on the enhanced mobile broadband (eMBB) and cMTC. However, there are still several other use cases whose requirements are higher than those of LPWA networks (i.e., LTE-M/NB-IoT) but lower than those of URLLC and eMBB. In order to efficiently support such use cases which are in-between eMBB. URLLC, and mMTC, 3GPP has studied reduced capability NR devices (RedCap) in 3GPP Release 17. A RedCap work item is expected to be finalized in September 2022. The RedCap wireless devices are required have at least one of lower cost, lower complexity, a longer battery life and potentially a smaller form factor than legacy NR wireless devices. Therefore, in 3GPP Rel-17, different complexity reduction features, such as reduced maximum wireless device bandwidth, reduced minimum number of receiver branches, reduced maximum number of DL MIMO layers, relaxed downlink modulation order, and support of half-duplex FDD operation will be specified for RedCap wireless devices.

The discussion on potential enhancements for RedCap in 3GPP Rel-18 may begin in 3GPP. One of the potential enhancements is related to support of RedCap wireless devices operating on harvested energy. The energy harvesting wireless devices are getting more attention as they can be self-sufficient, “green” and environmentally friendly and ideally perform a perpetual operation. The source of the harvested energy may be, for example, vibration, radio waves, indoor office light, etc. A typical characteristic of energy harvesting wireless devices is that the amount of energy that is available to communicate with the network is often varying drastically over time and is a stochastic process.

In general, the harvested energy cannot be used directly by the wireless device, but the wireless device needs to accumulate enough energy to perform an operation, e.g., a wireless transmission. Therefore, energy harvesting wireless devices need rechargeable batteries and/or capacitors to enable the storage and management of the harvested energy.

### Quality of Service (QOS) Flows

In 5G NR, incoming data packets from applications are classified into QoS Flows based on Packet Detection Rules (PDRs) in downlink and QoS rules in uplink, and then mapped to AN resources (i.e., Data Radio Bearers) for data transmission between the wireless device and network node, as illustrated in FIG. 1. Each QoS Flow may have its own 5G QoS Identifier (5QI), resource type, default priority level, packet delay budget, packet error rate, default maximum data burst volume, and default averaging window due to potentially different performance requirements for each service. However, these considered QoS Flows, applications, and services assume full energy at the wireless device side and currently do not consider the impact of energy harvesting.

One solution in 3GPP Technical Reference (TR) 23.724 for network controlled uplink (UL) data transmission delay is that the network authorizes the wireless device to delay the uplink data transmission within the configured delay tolerant window, and the wireless device can find a better coverage during the authorized delay tolerant window when there is uplink data to be transmitted. The high-level procedures and information flows are illustrated in FIG. 2. But this solution is only for uplink data transmission and network has no information about wireless device energy information for downlink data transmission.

### SUMMARY

Some embodiments advantageously provide methods, systems, and apparatuses for multi-level energy configuration for wireless devices that, for example, rely on harvested energy.

One or more embodiments described herein provide for communication optimization between network node and energy harvesting wireless device via multi-level energy configuration for different kinds of data radio bearers (DRBs), quality of service (QOS) Flows, services, and/or applications as well as corresponding energy warning mechanisms with more details provided below, where QoS Flow (QOS-Flow) can be replaced by DRB, Application, Service, or QoS Service (QOS-Service) to cover more cases because DRBs/applications/services may have its individual requirements in terms of priority, latency, power consumption, power consumption rate, and so on. For example, at least one solution may:
Define multi-level energy thresholds including new QoS Flow state, QoS-Flow (enter) enabling threshold, QoS-Flow (enter) disabling threshold, transmission enabling enter threshold, transmission enabling leave threshold, transmission disabling enter threshold, transmission disabling leave threshold, energy warning enter threshold and energy warning leave threshold.
Multi-level energy threshold configurations such as network-based configuration, wireless device-based configuration and pre-configuration at the wireless device side.
Energy warning reporting.
Transmission state reporting and transmission state update reporting.

One or more embodiments described herein can be beneficial for wireless device operation, wireless device energy efficiency, efficient scheduling and resource utilization, and QoS optimization.

According to one aspect of the present disclosure, an energy harvesting wireless device configured to communicate with a network node is provided. The energy harvesting wireless device includes processing circuitry configured to determine a first energy level of the energy harvesting wireless device meets a first threshold of a set of multi-level energy thresholds, and send to the network node a reporting indicating one of an enablement and disablement of a first communication configuration for a data flow of an application service based on the determination that the first threshold is met.

According to one or more embodiments of this aspect, the first communication configuration corresponds to a quality of service, QoS, flow state associated with whether data is allowed to be accepted by a data buffer. According to one or more embodiments of this aspect, the first communication configuration corresponds to one of a quality of service, QoS, flow and data radio bearer, DRB. According to one or more embodiments of this aspect, the first communication configuration corresponds to data transmission from the energy harvesting wireless device.

According to one or more embodiments of this aspect, the first threshold is one of: a quality of service, QoS, flow state enabling threshold; QoS flow state disabling threshold; QoS flow enabling threshold; QoS flow disabling threshold; transmission enabling threshold; and transmission disabling threshold. According to one or more embodiments of this aspect, the processing circuitry is further configured to: determine a second energy level of the energy harvesting wireless device meets a second threshold of the set of multi-level energy thresholds, the second threshold being different from the first threshold, and send to the network node a reporting indicating one of an enablement and disablement of a second communication configuration for the data flow of the application service based on the determination that the second threshold is met. According to one or more embodiments of this aspect, the processing circuitry is further configured to: determine a first energy level of the energy harvesting wireless device meets a warning threshold of the set of multi-level energy thresholds, and send to the network node a reporting indicating one of an enablement and disablement of an energy warning indication based on the determination that the warning threshold is met.

According to one or more embodiments of this aspect, the energy harvesting wireless device is preconfigured with the set of multi-level energy thresholds. According to one or more embodiments of this aspect, the processing circuitry is further configured to: receive one of dynamic and semi-static signaling indicating the set of multi-level energy thresholds, and monitor the energy level of the energy harvesting wireless device using the set of multi-level energy thresholds. According to one or more embodiments of this aspect, the reporting indicates at least one of: the set of multi-level energy thresholds are met; a preference regarding at least one thresholds of the multi-level energy thresholds; and at least one of energy harvesting capability, harvesting pattern and harvesting power per unit of time of the energy harvesting wireless device.

According to one or more embodiments of this aspect, the processing circuitry is further configured to suspend a N3 tunnel based on the first communication configuration having been disabled for a predefined period of time. According to one or more embodiments of this aspect, the processing circuitry is further configured to resume the N3 tunnel based on the re-enabling of the first communication configuration.

According to another aspect of the present disclosure, a network node configured to communicate with an energy harvesting wireless device is provided. The network node includes processing circuitry configured to: receive a reporting indicating at least a first threshold of a set of multi-level energy thresholds is met at the energy harvesting wireless device, determine one of an enablement and disablement of a first communication configuration for a data flow of an application service at the energy harvesting wireless device based on the first threshold is met, and perform communication with the energy harvesting wireless device based on the determination that the first threshold is met.

According to one or more embodiments of this aspect, the first communication configuration corresponds to a quality of service, QoS, flow state associated with whether data is allowed to be accepted by a data buffer of the energy harvesting wireless device. According to one or more embodiments of this aspect, the first communication configuration corresponds to one of a quality of service, QoS, flow and data radio bearer, DRB. According to one or more embodiments of this aspect, the first communication configuration corresponds to data 10 transmission from the energy harvesting wireless device.

According to one or more embodiments of this aspect, the first threshold is one of: a quality of service, QoS, flow state enabling threshold, QoS flow state disabling threshold, QoS flow enabling threshold, QoS flow disabling threshold, transmission enabling threshold, and transmission disabling threshold. According to one or more embodiments of this aspect, the processing circuitry is further configured to: receive a reporting indicating a second threshold of the set of multi-level energy thresholds is met, the second threshold being different from the first threshold, determine one of an enablement and disablement of a second communication configuration for the data flow of the application service at the energy harvesting wireless device based on the second threshold being met, and the communication with the energy harvesting wireless device is based on the determination that the second threshold being met. According to one or more embodiments of this aspect, the processing circuitry is further configured to cause transmission of one of dynamic and semi-static signaling indicating the set of multi-level energy thresholds for implementation by the energy harvesting wireless device.

According to another aspect of the present disclosure, a method implemented by an energy harvesting wireless device that is configured to communicate with a network node is provided. A determination is performed that a first energy level of the energy harvesting wireless device meets a first threshold of a set of multi-level energy thresholds. A reporting is send to the network node where the reporting indicate one of an enablement and disablement of a first communication configuration for a data flow of an application service based on the determination that the first threshold is met.

According to one or more embodiments of this aspect, the first communication configuration corresponds to a quality of service, QoS, flow state associated with whether data is allowed to be accepted by a data buffer. According to one or more embodiments of this aspect, the first communication configuration corresponds to one of a quality of service, QoS, flow and data radio bearer, DRB. According to one or more embodiments of this aspect, the first communication configuration corresponds to data transmission from the energy harvesting wireless device.

According to one or more embodiments of this aspect, the first threshold is one of: a quality of service, QoS, flow state enabling threshold, QoS flow state disabling threshold, Qos flow enabling threshold, QoS flow disabling threshold, transmission enabling threshold, and transmission disabling threshold. According to one or more embodiments of this aspect, a second energy level of the energy harvesting wireless device is determined to meet a second threshold of the set of multi-level energy thresholds where the second threshold is different from the first threshold. A reporting is send to the network node where the reporting indicates one of an enablement and disablement of a second communication configuration for the data flow of the application service based on the determination that the second threshold is met.

According to one or more embodiments of this aspect, a determination is performed that a first energy level of the energy harvesting wireless device meets a warning threshold of the set of multi-level energy thresholds. A reporting is sent to the network node where the reporting indicates one of an enablement and disablement of an energy warning indication based on the determination that the warning threshold is met. According to one or more embodiments of this aspect, the energy harvesting wireless device is preconfigured with the set of multi-level energy thresholds. According to one or more embodiments of this aspect, one of dynamic and semi-static signaling indicating the set of multi-level energy thresholds is received. The energy level of the energy harvesting wireless device is monitored using the set of multi-level energy thresholds.

According to one or more embodiments of this aspect, the reporting indicates at least one of the set of multi-level energy thresholds are met, a preference regarding at least one threshold of the multi-level energy thresholds, and at least one of energy harvesting capability, harvesting pattern, and harvesting power per unit of time of the energy harvesting wireless device. According to one or more embodiments of this aspect, a N3 tunnel is suspended based on the first communication configuration having been disabled for a predefined period of time. According to one or more embodiments of this aspect, the N3 tunnel is resumed based on the re-enabling of the first communication configuration.

According to another aspect of the present disclosure, a method implemented by a network node that is configured to communicate with an energy harvesting wireless device is provided. A reporting indicating at least a first threshold of a set of multi-level energy thresholds is met at the energy harvesting wireless device is received. A determination is perform of one of an enablement and disablement of a first communication configuration for a data flow of an application service at the energy harvesting wireless device based on the first threshold is met. Communication with the energy harvesting wireless device is performed based on the determination that the first threshold is met.

According to one or more embodiments of this aspect, the first communication configuration corresponds to a quality of service, QoS, flow state associated with whether data is allowed to be accepted by a data buffer of the energy harvesting wireless device. According to one or more embodiments of this aspect, the first communication configuration corresponds to one of a quality of service, QoS, flow and data radio bearer, DRB. According to one or more embodiments of this aspect, the first communication configuration corresponds to data transmission from the energy harvesting wireless device.

According to one or more embodiments of this aspect, the first threshold is one of: a quality of service, QoS, flow state enabling threshold, QoS flow state disabling threshold, Qos flow enabling threshold, QoS flow disabling threshold, transmission enabling threshold, and transmission disabling threshold. According to one or more embodiments of this aspect, a reporting indicating a second threshold of the set of multi-level energy thresholds is met is received where the second threshold being different from the first threshold. A determination is performed that one of enablement and disablement of a second communication configuration for the data flow of the application service at the energy harvesting wireless device based on the second threshold being met. The communication with the energy harvesting wireless device is based on the determination that the second threshold is met. According to one or more embodiments of this aspect, transmission is caused of one of dynamic and semi-static signaling indicating the set of multi-level energy thresholds for implementation by the energy harvesting wireless device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram for classification and user plane markings for QoS flows and mapping to AN resources;

FIG. 2 is a diagram of delay uplink transmission for a MO case;

FIG. 3 is a schematic diagram of an example network architecture illustrating a communication system connected via an intermediate network to a host computer according to the principles in the present disclosure:

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of another example process in a network node according to some embodiments of the present disclosure

FIG. 11 is a flowchart of an example process in a wireless device according to some embodiments of the present disclosure;

FIG. 12 is a flowchart of another example process in a wireless device according to some embodiments of the present disclosure;

FIG. 13 is a diagram of data flows of a wireless device, network node and UPF;

FIG. 14 is a diagram of a QoS flow state;

FIG. 15 is a diagram of another QoS flow state;

FIG. 16 is a diagram of QoS flow thresholds;

FIG. 17 is a diagram of QoS flow enter thresholds;

FIG. 18 is a diagram of transmission enabling thresholds;

FIG. 19 is a diagram of transmission disabling thresholds;

FIG. 20 is a diagram of energy warning thresholds; and

FIG. 21 is a diagram of an example for joint multi-level energy thresholds.

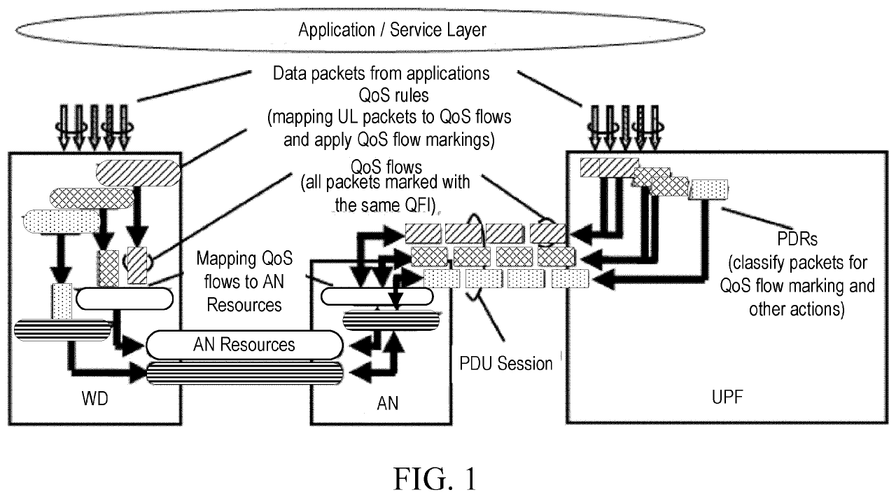

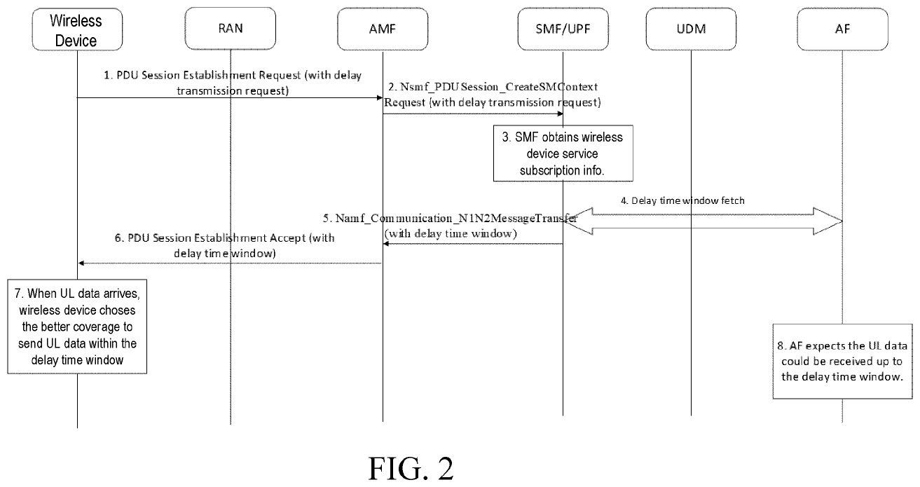

### DETAILED DESCRIPTION

Before describing in detail example embodiments, it is noted that the embodiments reside primarily in combinations of apparatus components and processing steps related to multi-level energy configuration for wireless devices that, for example, rely on harvested energy.

Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g . . . for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device or node may involve instructing and/or causing the wireless device or node to change its configuration, e.g., at least one setting and/or threshold and/or operational mode. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., allocation data (which may also be and/or comprise configuration data such as threshold data/criteria) and/or scheduling data and/or scheduling grants. Configuring a terminal may include sending allocation/configuration data to the terminal indicating one or more thresholds to implement.

In one or more embodiments, “reporting” may correspond to one or more reports. For example, transmitting reporting may correspond to the transmission of one or mor reports. In another example, receiving reporting may correspond to receiving one or more reports.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide multi-level energy configuration for wireless devices that, for example, rely on harvested energy.

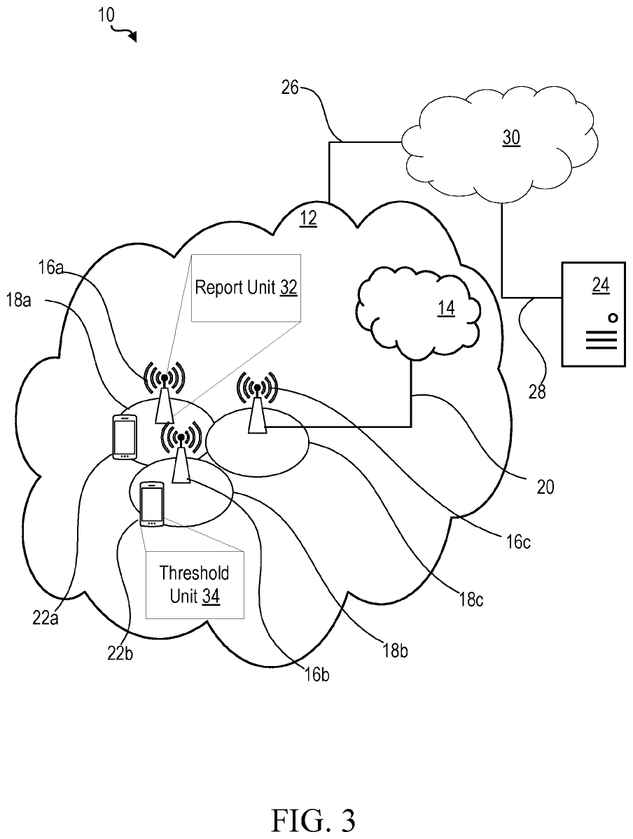

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a report unit 32 which is configured to perform one or more network node 16 functions as described herein such as with respect to a multi-level energy configuration for wireless devices that, for example, rely on harvested energy. A wireless device 22 is configured to include a threshold unit 34 which is configured to perform one or more wireless device 22 functions as described herein such as with respect to a multi-level energy configuration for wireless devices that, for example, rely on harvested energy.

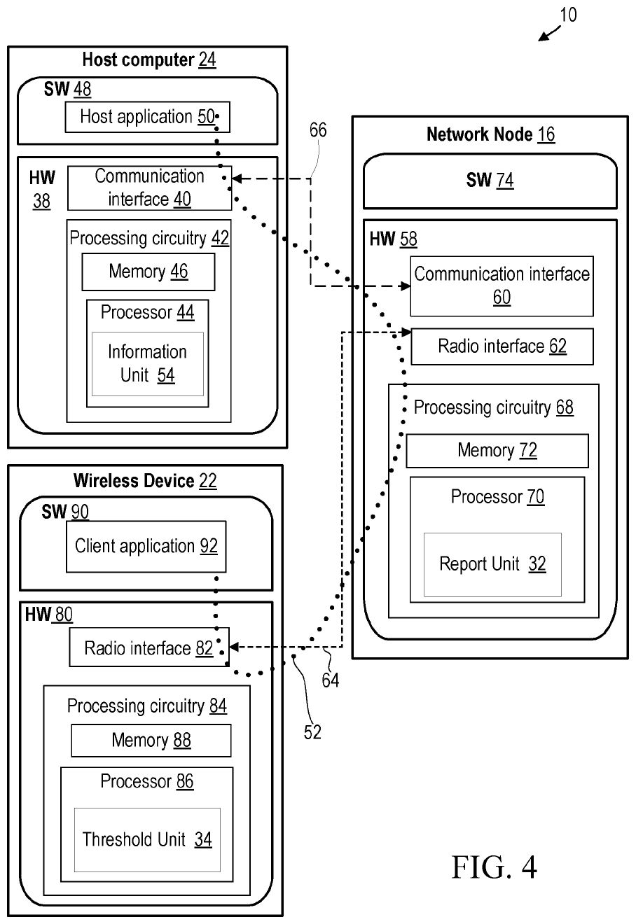

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to relay, forward, transmit, receive, process, analyze, store, etc., information related to multi-level energy configuration for wireless devices that, for example, rely on harvested energy.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include report unit 32 configured to perform one or more network node 16 functions as described herein such as those functions related to a multi-level energy configuration for wireless devices that, for example, rely on harvested energy.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a threshold unit 34 configured to perform one or more wireless device 22 functions as described herein such as those functions related to multi-level energy configuration for wireless devices that, for example, rely on harvested energy.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as report unit 32, and threshold unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

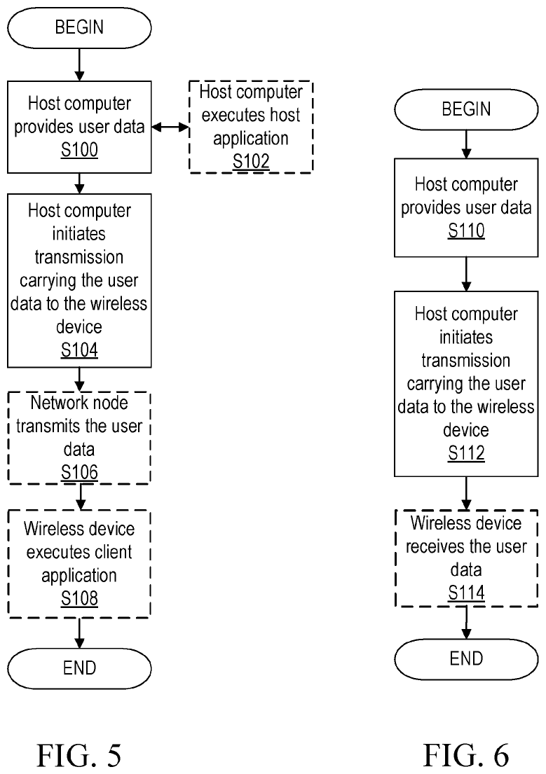

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

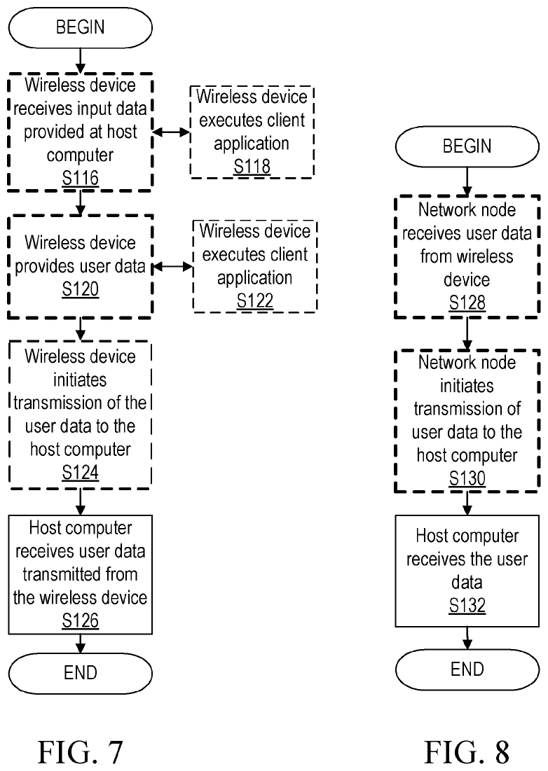

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

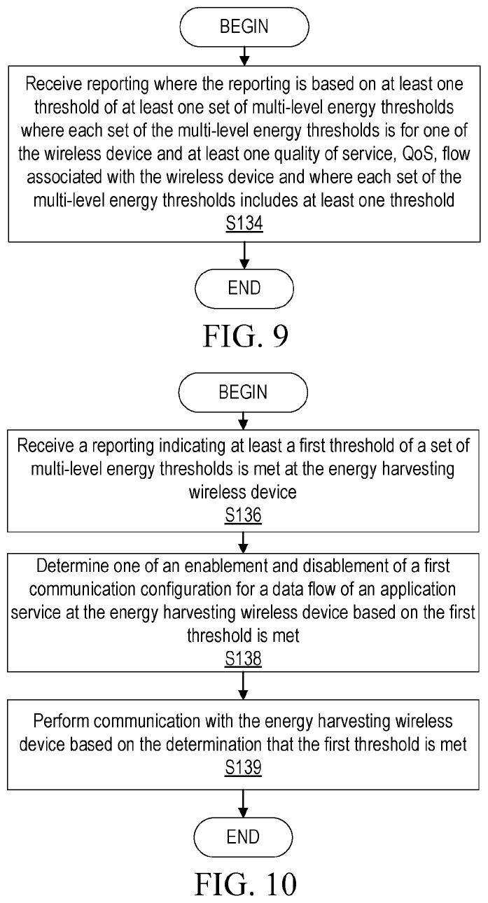

FIG. 9 is a flowchart of an example process in a network node 16 according to some embodiments of the present disclosure. One or more blocks described herein may be performed by one or more elements of network node 16 such as by one or more of processing circuitry 68 (including the report unit 32), processor 70, radio interface 62 and/or communication interface 60. Network node 16 is configured to receive (Block S134) reporting where the reporting is based on at least one threshold of at least one set of multi-level energy thresholds and where each set of the multi-level energy thresholds is for one of the wireless device 22 and at least one quality of service, QoS, flow associated with the wireless device 22, and where each set of the multi-level energy thresholds includes at least one threshold, as described herein.

In particular, in one or more embodiments, there can be multiple/several QoS flows associated with one wireless device 22 where the threshold can either be based on one of the QoS flows or based on some of the QoS flows (it can be averaged QoS requirements or based on the higher priority QoS requirements). In one or more embodiments, the threshold can be either used for the entire wireless device 22 (e.g., all services or QoS based services associated with or running at the wireless device 22) or for one or more but not all of the services in the wireless device 22.

According to one or more embodiments, the at least one threshold is used to determine whether to one of suspend, resume, stop, start and restart one of a service, communication and data flow at the wireless device. According to one or more embodiments, the at least one threshold is used as a warning as to whether to one of suspend, resume, stop, start and restart one of a service, communication and data flow at the wireless device.

According to one or more embodiments, the processing circuitry 68 is further configured to configure the wireless device with the at least one set of the multi-level energy thresholds. According to one or more embodiments, the reporting is one of a transmission state reporting, transmission state update reporting, energy warning reporting and data radio bearer, DRB, status. According to one or more embodiments, one set of multi-level energy thresholds includes at least one of: a QoS-Flow enabling threshold; a QoS-Flow disabling threshold; a QoS-Flow enter enabling threshold; a QoS-Flow enter disabling threshold; a service enabling threshold; a service disabling threshold; a service enter enabling threshold; a service enter disabling threshold; a DRB enabling threshold; a DRB disabling threshold; a DRB enter enabling threshold; a DRB enter disabling threshold; a transmission enabling threshold; a transmission enabling enter threshold; a transmission enabling leave threshold; a transmission disabling threshold; a transmission disabling enter threshold; a transmission disabling leave threshold; an energy warning enter threshold; and an energy warning leave threshold.

FIG. 10 is a flowchart of an example process in a network node 16 according to some embodiments of the present disclosure. One or more blocks described herein may be performed by one or more elements of network node 16 such as by one or more of processing circuitry 68 (including the report unit 32), processor 70, radio interface 62 and/or communication interface 60. Network node 16 is configured to receive (Block S136) a reporting indicating at least a first threshold of a set of multi-level energy thresholds is met at the energy harvesting wireless device 22, as described herein. Network node 16 is configured to determine (Block S138) one of an enablement and disablement of a first communication configuration for a data flow of an application service at the energy harvesting wireless device 22 based on the first threshold is met, as described herein. Network node 16 is configured to perform (Block S139) communication with the energy harvesting wireless device 22 based on the determination that the first threshold is met, as described herein.

According to one or more embodiments, the first communication configuration corresponds to a quality of service, QoS, flow state associated with whether data is allowed to be accepted by a data buffer of the energy harvesting wireless device 22. According to one or more embodiments, the first communication configuration corresponds to one of a quality of service, QoS, flow and data radio bearer, DRB. According to one or more embodiments, the first communication configuration corresponds to data transmission from the energy harvesting wireless device 22. According to one or more embodiments, the first threshold is one of: a quality of service, QoS, flow state enabling threshold, QoS flow state disabling threshold. QoS flow enabling threshold, QoS flow disabling threshold, transmission enabling threshold, and transmission disabling threshold.

According to one or more embodiments, the processing circuitry 68 is further configured to: receive a reporting indicating a second threshold of the set of multi-level energy thresholds is met where the second threshold is different from the first threshold, and determine one of an enablement and disablement of a second communication configuration for the data flow of the application service at the energy harvesting wireless device 22 based on the second threshold being met, where the communication with the energy harvesting wireless device 22 is based on the determination that the second threshold being met.

According to one or more embodiments, the processing circuitry 68 is further configured to cause transmission of one of dynamic and semi-static signaling indicating the set of multi-level energy thresholds for implementation by the energy harvesting wireless device 22.

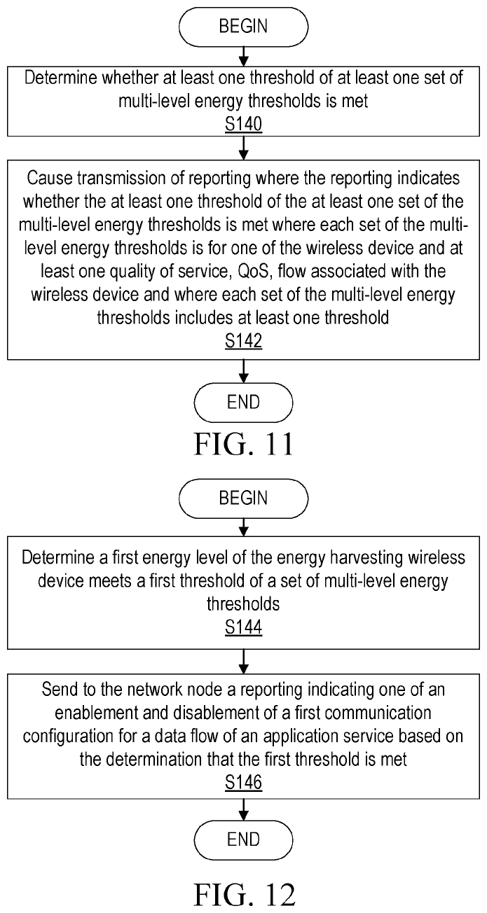

FIG. 11 is a flowchart of an example process in a wireless device 22 according to some embodiments of the present disclosure. One or more blocks described herein may be performed by one or more elements of wireless device 22 such as by one or more of processing circuitry 84 (including the threshold unit 34), processor 86, radio interface 82 and/or communication interface 60. Wireless device 22 is configured to determine (Block S140) whether at least one threshold of at least one set of multi-level energy thresholds is met, as described herein.

Wireless device 22 is configured to cause (Block S142) transmission of reporting where the reporting indicates whether the at least one threshold of the at least one set of the multi-level energy thresholds is met, and where each set of the multi-level energy thresholds being for one of the wireless device and at least one quality of service, QoS, flow associated with the wireless device 22, and where each set of the multi-level energy thresholds includes at least one threshold, as described herein.

According to one or more embodiments, the processing circuitry 84 is further configured to use the at least one threshold to determine whether to one of suspend, resume, stop and restart one of a service, communication and data flow at the wireless device 22, as described herein. According to one or more embodiments, the processing circuitry 84 is further configured to use the at least one threshold as a warning as to whether to one of suspend, resume, stop, start and restart one of a service, communication and data flow at the wireless device 22, as described herein.

According to one or more embodiments, the processing circuitry 84 is further configured to implement a configuration of the at least one set of the multi-level energy thresholds that is one of received from the network node and pre-stored at the wireless device 22, as described herein. According to one or more embodiments, the reporting is one of a transmission state reporting, transmission state update reporting, energy warning reporting and data radio bearer, DRB, status, as described herein. According to one or more embodiments, one set of the multi-level energy thresholds include at least one of: a QoS-Flow enabling threshold; a QoS-Flow disabling threshold; a QoS-Flow enter enabling threshold; a QoS-Flow enter disabling threshold; a service enabling threshold; a service disabling threshold; a service enter enabling threshold; a service enter disabling threshold; a DRB enabling threshold; a DRB disabling threshold; a DRB enter enabling threshold; a DRB enter disabling threshold; a transmission enabling threshold; a transmission enabling enter threshold; a transmission enabling leave threshold; a transmission disabling threshold; a transmission disabling enter threshold; a transmission disabling leave threshold; an energy warning enter threshold; and an energy warning leave threshold.

FIG. 12 is a flowchart of an example process in a wireless device 22 (e.g., energy harvesting wireless device 22) according to some embodiments of the present disclosure. One or more blocks described herein may be performed by one or more elements of wireless device 22 such as by one or more of processing circuitry 84 (including the threshold unit 34), processor 86, radio interface 82 and/or communication interface 60. Wireless device 22 is configured to determine (Block S144) a first energy level of the energy harvesting wireless device 22 meets a first threshold of a set of multi-level energy thresholds, as described herein. Wireless device 22 is configured to send (Block S146) to the network node 16 a reporting indicating one of an enablement and disablement of a first communication configuration for a data flow of an application service based on the determination that the first threshold is met, as described herein.

According to one or more embodiments, the first communication configuration corresponds to a quality of service, QoS, flow state associated with whether data is allowed to be accepted by a data buffer. According to one or more embodiments, the first communication configuration corresponds to one of a quality of service, QoS, flow and data radio bearer, DRB. According to one or more embodiments, the first communication configuration corresponds to data transmission from the energy harvesting wireless device 22.

According to one or more embodiments, the first threshold is one of: a quality of service, QoS, flow state enabling threshold, QoS flow state disabling threshold, QoS flow enabling threshold, QoS flow disabling threshold, transmission enabling threshold, and transmission disabling threshold. According to one or more embodiments, the processing circuitry 84 is further configured to: determine a second energy level of the energy harvesting wireless device meets a second threshold of the set of multi-level energy thresholds where the second threshold is different from the first threshold, and send to the network node 16 a reporting indicating one of an enablement and disablement of a second communication configuration for the data flow of the application service based on the determination that the second threshold is met. According to one or more embodiments, the processing circuitry 84 is further configured to: determine a first energy level of the energy harvesting wireless device 22 meets a warning threshold of the set of multi-level energy thresholds, and send to the network node 16 a reporting indicating one of an enablement and disablement of an energy warning indication based on the determination that the warning threshold is met.

According to one or more embodiments, the energy harvesting wireless device 22 is preconfigured with the set of multi-level energy thresholds. According to one or more embodiments, the processing circuitry 84 is further configured to: receive one of dynamic and semi-static signaling indicating the set of multi-level energy thresholds; and monitor the energy level of the energy harvesting wireless device 22 using the set of multi-level energy thresholds.

According to one or more embodiments, the reporting indicates at least one of: the set of multi-level energy thresholds are met, a preference regarding at least one thresholds of the multi-level energy thresholds; and at least one of energy harvesting capability, harvesting pattern and harvesting power per unit of time of the energy harvesting wireless device 22. According to one or more embodiments, the processing circuitry 84 is further configured to suspend a N3 tunnel based on the first communication configuration having been disabled for a predefined period of time. According to one or more embodiments, the processing circuitry is further configured to resume the N3 tunnel based on the re-enabling of the first communication configuration. Having generally described arrangements for multi-level energy configuration for wireless devices that, for example, rely on harvested energy, functions and processes are provided as follows, and which may be implemented by the network node 16, wireless device 22 and/or host computer 24. One or more wireless device 22 functions described below may be performed by one or more of processing circuitry 84, processor 86, threshold unit 34, radio interface 82, etc. One or more network node 16 functions described below may be performed by one or more of processing circuitry 68, processor 70, report unit 32, radio interface 62, etc.

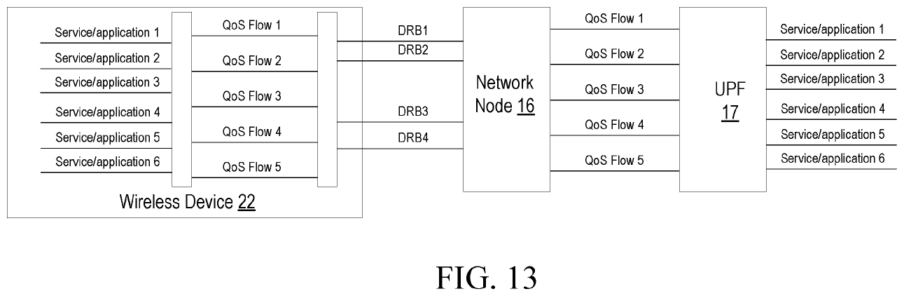

Some embodiments provide multi-level energy configuration for wireless devices that, for example, rely on harvested energy (e.g., energy harvesting wireless device 22). FIG. 13 is a diagram of an example system overview of data flows of wireless device 22, network node 16 and user plane function (UPF) 17 based on the disclosure herein.

Note: QoS Flow (QOS-Flow) in this section can be replaced by DRB, Application, Service or QoS Service (QOS-Service) to cover more cases because applications/services may have its individual requirements in terms of priority, latency, power consumption, power consumption rate, and so on.

### QoS Flow State

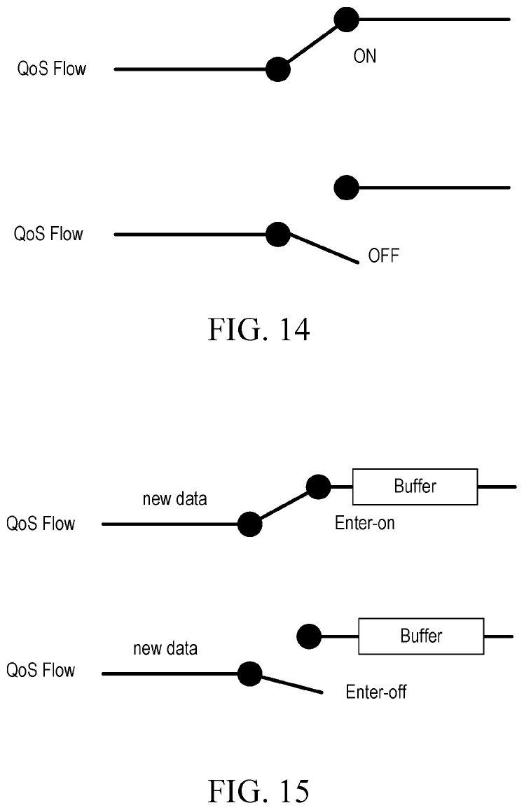

One QoS Flow is associated with one state information. If this state is “on”, then this QoS Flow is enabled. If this state is “off”, then this QoS Flow is disabled as illustrated in FIG. 14. In another embodiment, this state information can be ‘resuming’ and ‘suspending’.

One QoS Flow is associated with one state information. If this state is “enter-on”, then the data buffer of this QoS Flow is enabled to accept new data. If this state is “enter-off”, then the data buffer of this QoS Flow is disabled to accept new data. The data buffer of this QoS Flow may be data transmission buffer and/or data receive buffer. FIG. 15 is diagram of these QoS flow state having the data buffer.

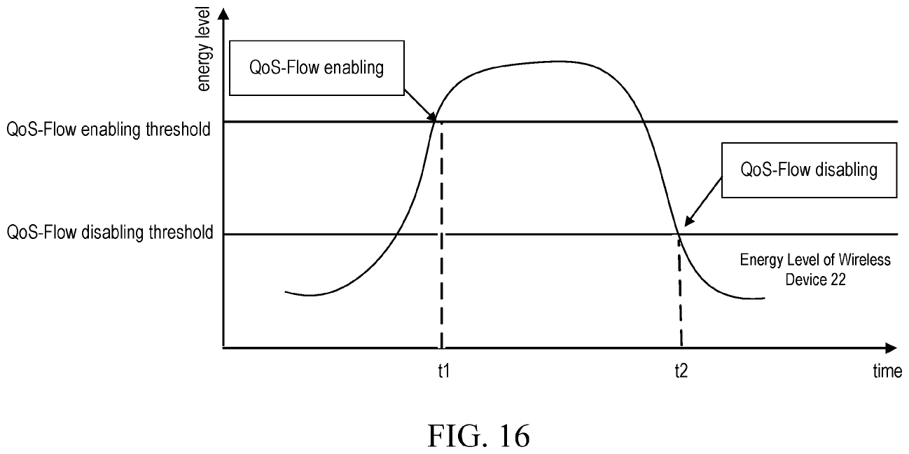

### QoS-Flow Thresholds as Illustrated in FIG. 16

As shown in FIG. 16, one QoS Flow has one QoS-Flow enabling threshold and one QoS-Flow disabling threshold to control its state switching. The state of one QoS Flow of one wireless device 22 is set to from ‘off’ to ‘on’ at time t1 when the energy level of this wireless device 22 is increased to its QoS-Flow enabling threshold, and is set from ‘on’ to ‘off’ at time 2 when the energy level of this wireless device 22 in decreased to its QoS-Flow disabling threshold.

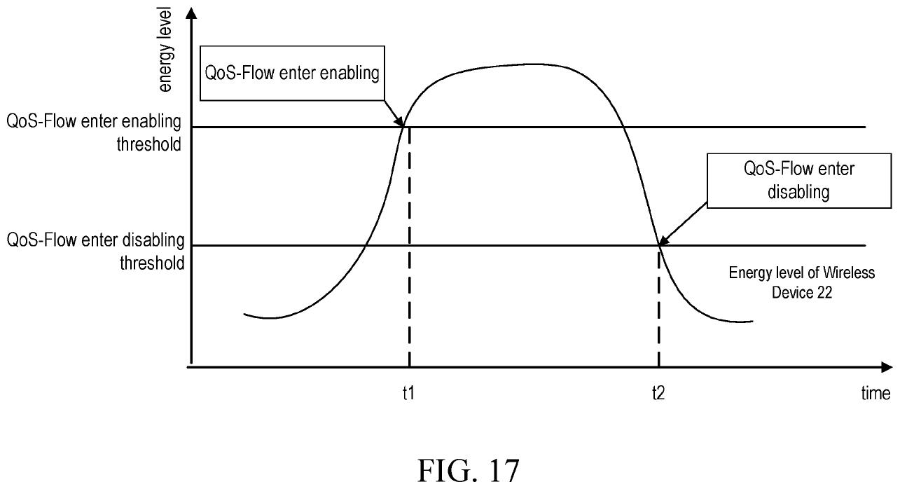

Thus, as shown in FIG. 17, one QoS Flow has one QoS-Flow enter enabling threshold and one QoS-Flow enter disabling threshold to control its state switching. As illustrated in FIG. 17, the state of one QoS Flow of one wireless device 22 is set to from ‘enter-off’ to ‘enter-on’ at time t1 when the energy level of this wireless device 22 is increased to its QoS-Flow enter enabling threshold, and is set from ‘enter-on’ to ‘enter-off’ at time t2 when the energy level of this wireless device 22 in decreased to its QoS-Flow enter disabling threshold.

### Transmission Enabling Thresholds

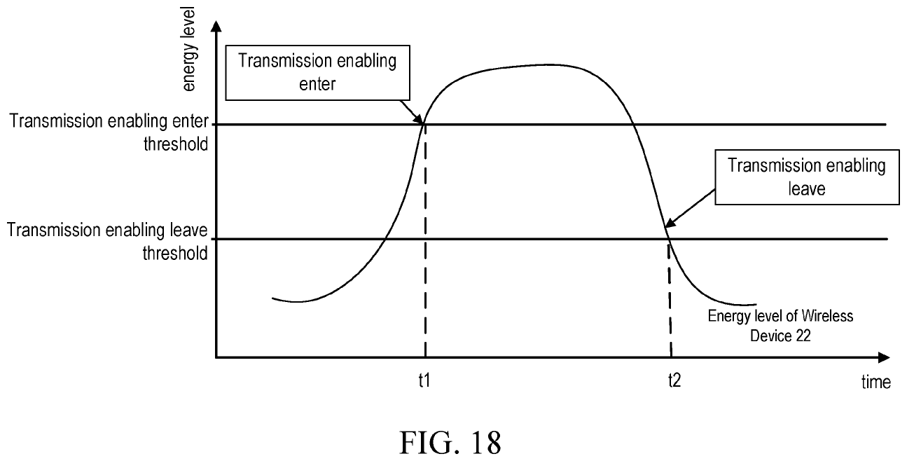

In another embodiment, one QoS Flow may be associated with at least one of transmission enabling threshold, transmission enabling enter threshold and transmission enabling leave threshold to control its transmission enabling as illustrated in FIG. 18. As illustrated in FIG. 18, transmission enabling of corresponding QoS Flow is triggered at time t1 when the energy level of one wireless device is increased to its transmission enabling enter threshold and released at time t2 when the energy level of this wireless device is reduced to its transmission enabling leave threshold.

### Transmission Disabling Thresholds

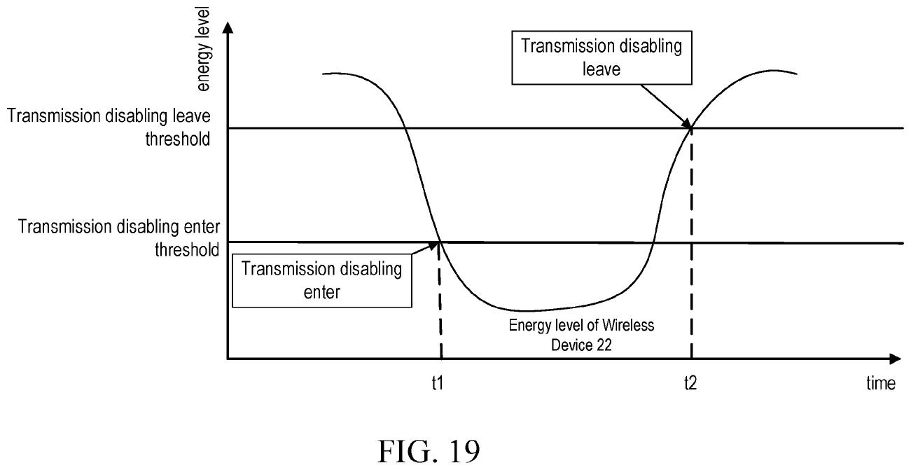

In another embodiment, one QoS Flow may be associated with at least one of transmission disabling threshold, transmission disabling enter threshold and transmission disabling leave threshold to control its transmission disabling as illustrated in FIG. 19. As illustrated in FIG. 19, transmission disabling of corresponding QoS Flow is triggered at time t1 when the energy level of one wireless device 22 is reduced to its transmission disabling enter threshold and released at time t2 when the energy level of this wireless device 22 is increased to its transmission disabling leave threshold.

### Energy Warning Thresholds

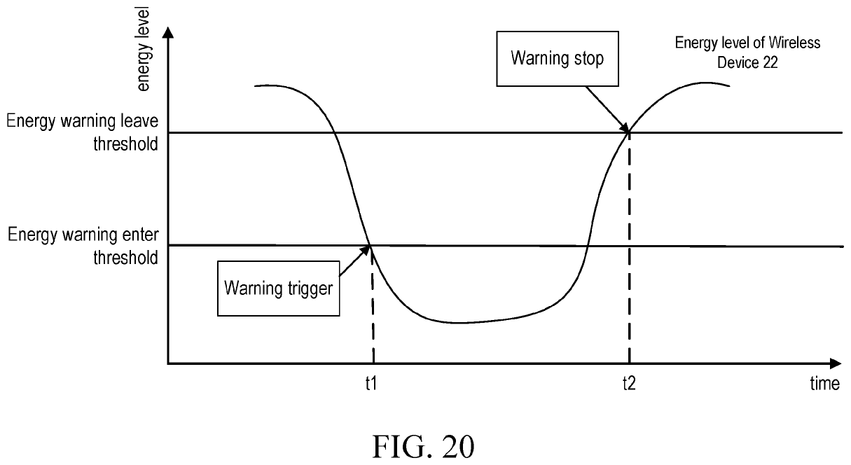

The energy warning threshold may include one energy warning enter threshold and one energy warning leave threshold as illustrated in FIG. 20. Energy warning for a given condition is triggered at time t1 when the energy level of one wireless device 22 is reduced to its energy warning enter threshold and it stops at time t2 when the energy level of this wireless device 22 is increased to its energy warning leave threshold.

### Multi-Level Energy Threshold Configuration

One or more of the thresholds described above may be jointly used and may be time-varying depending on the scenarios, environments, energy harvesting pattern, etc. That is, wireless device 22 may monitor an energy level of the wireless device 22 to determine if the monitored energy level meets one or more thresholds.

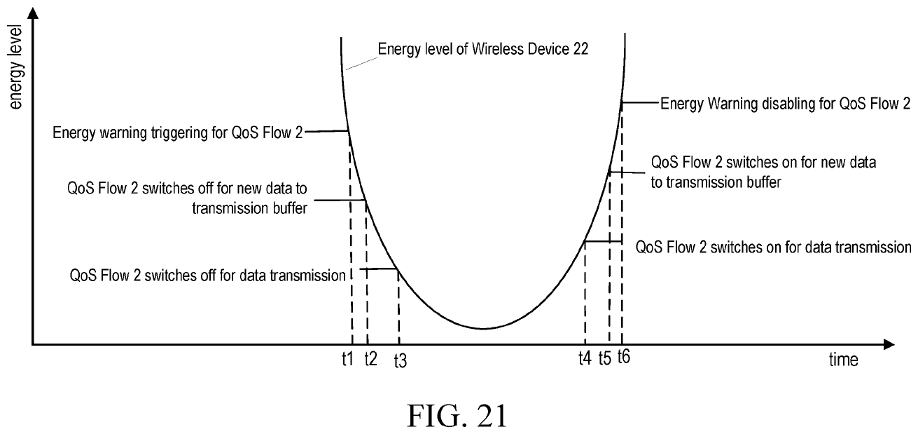

In one embodiment, as illustrated in FIG. 21, for QoS Flow 2, energy warning is triggered at time t1, new data to transmission buffer is disabled at time t2, data transmission is disabled at time t3 due to the reduction of wireless device 22's energy level, but data transmission is enabled at time t4, new data to transmission buffer is enabled at time t5, and energy warning is disabled at time t6. In one or more embodiments, the wireless device 22 performs the disabling/enabling of one or more communication configurations (e.g., QoS flows, QoS states, transmission disable, transmission enabled, etc.) based on one or more thresholds.

### Pre-Configuration at Wireless Device 22 Side

One wireless device 22 can be pre-configured with one or more energy threshold sets where one energy threshold set is for one or more QoS Flow(s) (or for this wireless device 22) (for example, by servicers, operators, customers, vendors and so on) and may include one or more energy thresholds such as one or more of:
One energy threshold set may be for one supported QoS Flow, each group of supported QoS Flows, or default QoS Flow.
One energy threshold set may include at least one of the following thresholds:
   QoS-Flow enabling threshold
   QoS-Flow disabling threshold
   QoS-Flow enter enabling threshold
   QoS-Flow enter disabling threshold
   Transmission enabling threshold
   Transmission enabling enter threshold
   Transmission enabling leave threshold
   Transmission disabling threshold
   Transmission disabling enter threshold
   Transmission disabling leave threshold
   Energy warning enter threshold
   Energy a service enabling threshold
   A service disabling threshold
   A service enter enabling threshold
   A service enter disabling threshold
   A DRB flow enabling threshold
   A DRB flow disabling threshold
   A DRB flow enter enabling threshold
   A DRB flow enter disabling threshold
   A flow enabling threshold
   A flow disabling threshold
   A flow enter enabling threshold

### A Flow Enter Disabling Threshold Warning Leave Threshold

Network/Network Node 16-based configuration

Network node 16 (or network) can dynamically or semi-statically configure one or more sets of energy warning enter and leave thresholds to wireless device 22, and one set of warning energy enter and leave thresholds may correspond to one or more QoS Flow(s) for this wireless device 22 and may be obtained based on one or more of QoS-Flow (enter) enabling threshold, QoS-Flow (enter) disabling threshold, transmission disabling threshold, transmission disabling enter threshold, transmission disabling leave threshold, transmission enabling threshold, transmission enabling enter threshold and/or transmission enabling leave threshold of this wireless device 22 and/or other information.

Network node 16 can dynamically or semi-statically indicate to wireless device 22 about one or more energy threshold sets where one energy threshold set is for one or more QoS Flow(s) or for this wireless device 22. One energy threshold set may include one or more of: one QoS-Flow (enter) enabling threshold, one QoS-Flow (enter) disabling threshold, one transmission enabling threshold, one transmission enabling enter threshold, one transmission enabling leave threshold, one transmission disabling threshold, one transmission disabling enter threshold, and/or one transmission disabling leave threshold.

For example, in one embodiment, the wireless device 22 indicates to the network node 16 one or more of: its energy harvesting capability, harvesting profile/pattern, harvesting power per unit of time, etc. In response to the received information, the network node 16 can provide the configuration of one or more of the QoS flow related parameters as disclosed above to wireless device 22. The configuration can be provided thought higher layer signalling, e.g., radio resource control (RRC) signalling, dedicated signalling, NAS, or through L1/L2 signalling, e.g., the wireless device 22 may be configured with a number of thresholds per parameter, and a MAC CE command is used to enable corresponding active threshold for each parameter. The advantage of the latter is that since most of the energy harvesting wireless devices 22 do not follow a stable predictable condition, and thus the harvesting profile/pattern/rate changes over time, it may be necessary to more dynamically update the associated parameters.

### Wireless Device 22-Based Configuration

One wireless device 22 may notify the network node 16 or network about one or more energy threshold sets where one energy threshold set is for one or more QoS Flow(s) or for this wireless device 22. One energy threshold set may include one QoS-Flow (enter) enabling threshold, one QoS-Flow (enter) disabling threshold, one transmission enabling enter threshold, one transmission enabling leave threshold, one transmission disabling enter threshold, and/or one transmission disabling leave threshold.

In another yet related embodiment, the wireless device 22 may indicate to the network node 16 of its preference regarding one or more QoS thresholds that are disclosed above, in addition to its harvesting profile/pattern/rate/etc. And in response to that the network node 16 either confirms the wireless device 22 preferences, or one or more of them, or alternatively, configures the wireless device 22 with one or more configurations that it can support. The wireless device 22 preference can be set to be part of the connection establishment, a capability report, or based on network node 16 requests (e.g., aperiodic), or on a periodic basis if the wireless device 22 is configured as such.

### Energy Warning Reporting

In one or more embodiments, the procedure for energy warning reporting is as follows:

Step 1: Network node 16 can send a message to wireless device 22 for energy warning reporting from this wireless device 22. This message may include at least one of ID(s) of QoS Flow(s), corresponding energy warning threshold(s) and report period(s).
One QoS Flow ID may be associated with one energy waring enter threshold, one energy warning leave threshold and/or one report period.
There may be only one report period shared by all energy warning.
There may be one report period for energy warning about a group of QoS Flows.

Step 2: wireless device 22 can report its energy level to network node 16 once the energy warning for the QoS Flow(s) mentioned in Step 1 is triggered. This report may be periodical until all its energy warning are disabled. Wireless device 22 may report energy warning type with more detailed information about specific QoS Flow(s).

In one or more embodiments, wireless device 22 may be allowed to indicate to network node 16 that it has reached the energy warning state even if network node 16 did not explicitly ask for or request it, e.g., through a configured grant/PRACH, etc.

In one embodiment, network node 16 or wireless device 22 may notify the receiving application(s) or the transmitting application(s), e.g., when there is not enough power to send a message with certain QoS, and the notification can be a message or a timer that the expected message may not come this time or within a given time window. Similarly, a message could be sent to the sensor that no measurement is needed at this time or within a given time window because there is not enough power to transmit the current value or transmit the current value with a given QoS.

### Transmission State Reporting

### In One or More Embodiments, the Procedure is:

Step 1: Network node 16 can send a message to wireless device 22 to enable energy state reporting from this wireless device 22. This message may include QoS Flow ID information.

Step 2: Wireless device 22 can report its energy state to network node 16 based on the received message. This energy state may include a transmission state of QoS Flow indicated by network or QoS Flow supported by wireless device 22.

In one or more embodiments, wireless device 22 may be allowed to indicate to network node 16 its energy state information even if network node 16 did not explicitly ask for or request it, e.g., through a configured grant/PRACH, etc.

### Transmission State Update Reporting

### In One or More Embodiments, the Procedure Includes:

Step 1: Network node 16 can send message to wireless device 22 to enable energy state update reporting from this wireless device 22.

Step 2: Wireless device 22 can report its energy state update to network node 16 once there is energy state update for its supported QoS Flows, active QoS Flows and/or indicated QoS Flows.

In one or more embodiments, wireless device 22 may be allowed to indicate to network node 16 its energy state update information even if network node 16 did not explicitly ask for or request it, e.g., through a configured grant/PRACH, etc.

### DRB Resuming/Suspending/Removing

If all of QoS Flows of one DRB/N3 tunnel of one wireless device 22 have been suspended/removed for at least a longer time, then this DRB/N3 tunnel can be suspended/removed. If one DRB/N3 tunnel of this wireless device 22 has been suspended but one of QoS Flows of this DRB/N3 tunnel has been resumed, then this DRB/N3 will be resumed.

### Examples

Example A1. A network node 16 configured to communicate with a wireless device 22 (WD 22), the network node 16 configured to, and/or comprising a radio interface 62 and/or comprising processing circuitry 68 configured to:
receive reporting, the reporting being based on at least one threshold of at least one set of multi-level energy thresholds, each set of the multi-level energy thresholds being for one of the wireless device 22 and at least one quality of service, QoS, flow associated with the wireless device 22, each set of the multi-level energy thresholds including at least one threshold.

Example A2. The network node 16 of Example A1, wherein the at least one threshold is used to determine whether to one of suspend, resume, stop, start and restart one of a service, communication and data flow at the wireless device 22.

Example A3. The network node 16 of Example A1, wherein the at least one threshold is used as a warning as to whether to one of suspend, resume, stop, start and restart one of a service, communication and data flow at the wireless device 22.

Example A4. The network node 16 of Example A1, wherein the processing circuitry 68 is further configured to configure the wireless device 22 with the at least one set of the multi-level energy thresholds.

Example A5. The network node 16 of Example A1, wherein the reporting is one of a transmission state reporting, transmission state update reporting, energy warning reporting and data radio bearer, DRB, status.

Example A6. The network node 16 of Example A1, wherein one set of the multi-level energy thresholds includes at least one of:
a QoS-Flow enabling threshold;
a QoS-Flow disabling threshold;
a QoS-Flow enter enabling threshold;
a QoS-Flow enter disabling threshold;
a service enabling threshold;
a service disabling threshold;
a service enter enabling threshold;
a service enter disabling threshold;
a DRB flow enabling threshold;
a DRB flow disabling threshold;
a DRB flow enter enabling threshold;
a DRB flow enter disabling threshold;
a flow enabling threshold;
a flow disabling threshold;
a flow enter enabling threshold;
a flow enter disabling threshold;
a transmission enabling threshold;
a transmission enabling enter threshold;
a transmission enabling leave threshold;
a transmission disabling threshold;
a transmission disabling enter threshold;
a transmission disabling leave threshold;
an energy warning enter threshold; and
an energy warning leave threshold.

Example B1. A method implemented in a network node 16 that is configured to communicate with a wireless device 22, the method comprising:
receiving reporting, the reporting being based on at least one threshold of at least one set of multi-level energy thresholds, each set of the multi-level energy thresholds being for one of the wireless device 22 and at least one quality of service, QoS, flow associated with the wireless device 22, each set of the multi-level energy thresholds including at least one threshold.

Example B2. The method of Example B1, wherein the at least one threshold is used to determine whether to one of suspend, resume, stop, start and restart one of a service, communication and data flow at the wireless device 22.

Example B3. The method of Example B1, wherein the at least one threshold is used as a warning as to whether to one of suspend, resume, stop, start and restart one of a service, communication and data flow at the wireless device 22.

Example B4. The method of Example B1, further comprising configuring the wireless device 22 with the at least one set of the multi-level energy thresholds.

Example B5. The method of Example B1, wherein the reporting is one of a transmission state reporting, transmission state update reporting, energy warning reporting and data radio bearer, DRB, status.

Example B6. The method of Example B1, wherein one set of the multi-level energy thresholds includes at least one of:
a QoS-Flow enabling threshold;
a QoS-Flow disabling threshold;
a QoS-Flow enter enabling threshold;
a QoS-Flow enter disabling threshold;
a service enabling threshold;
a service disabling threshold;
a service enter enabling threshold;
a service enter disabling threshold;
a DRB flow enabling threshold;
a DRB flow disabling threshold;
a DRB flow enter enabling threshold;
a DRB flow enter disabling threshold;
a flow enabling threshold;
a flow disabling threshold;
a flow enter enabling threshold;
a flow enter disabling threshold;
a transmission enabling threshold;
a transmission enabling enter threshold;
a transmission enabling leave threshold;
a transmission disabling threshold;
a transmission disabling enter threshold;
a transmission disabling leave threshold;
an energy warning enter threshold; and
an energy warning leave threshold.

Example C1. A wireless device 22 (WD 22) configured to communicate with a network node 16, the WD 22 configured to, and/or comprising a radio interface 82 and/or processing circuitry 84 configured to:
determine whether at least one threshold of at least one set of multi-level energy thresholds is met; and
cause transmission of reporting, the reporting indicating whether the at least one threshold of the at least one set of the multi-level energy thresholds is met, each set of the multi-level energy thresholds being for one of the wireless device 22 and at least one quality of service, QoS, flow associated with the wireless device 22, each set of the multi-level energy thresholds including at least one threshold.

Example C2. The WD 22 of Example C1, wherein the processing circuitry 84 is further configured to use the at least one threshold to determine whether to one of suspend, resume, stop and restart one of a service, communication and data flow at the wireless device 22.

Example C3. The WD 22 of Example C1, wherein the processing circuitry 84 is further configured to use the at least one threshold as a warning as to whether to one of suspend, resume, stop, start and restart one of a service, communication and data flow at the wireless device 22.

Example C4. The WD 22 of Example C1, wherein the processing circuitry 84 is further configured to implement a configuration of the at least one set of the multi-level energy thresholds that is one of received from the network node 16 and pre-stored at the wireless device 22.

Example C5. The WD 22 of Example C1, wherein the reporting is one of a transmission state reporting, transmission state update reporting, energy warning reporting and data radio bearer, DRB, status.

Example C6. The WD 22 of Example C1, wherein one set of the multi-level energy thresholds includes at least one of:
a QoS-Flow enabling threshold;
a QoS-Flow disabling threshold;
a QoS-Flow enter enabling threshold;
a QoS-Flow enter disabling threshold;
a service enabling threshold;
a service disabling threshold;
a service enter enabling threshold;
a service enter disabling threshold;
a DRB flow enabling threshold;
a DRB flow disabling threshold;
a DRB flow enter enabling threshold;
a DRB flow enter disabling threshold;
a flow enabling threshold;
a flow disabling threshold;
a flow enter enabling threshold;
a flow enter disabling threshold;
a transmission enabling threshold;
a transmission enabling enter threshold;
a transmission enabling leave threshold;
a transmission disabling threshold;
a transmission disabling enter threshold;
a transmission disabling leave threshold;
an energy warning enter threshold; and
an energy warning leave threshold.

Example D1. A method implemented in a wireless device 22 that is configured to communicate with a network node 16, the method comprising:
determining whether at least one threshold of at least one set of multi-level energy thresholds is met; and
causing transmission of reporting, the reporting indicating whether the at least one threshold of the at least one set of the multi-level energy thresholds is met, each set of the multi-level energy thresholds being for one of the wireless device 22 and at least one quality of service, QoS, flow associated with the wireless device 22, each set of the multi-level energy thresholds including at least one threshold.

Example D2. The method of Example D1, further comprising using the at least one threshold to determine whether to one of suspend, resume, stop and restart one of a service, communication and data flow at the wireless device 22.

Example D3. The method of Example D1, further comprising using the at least one threshold as a warning as to whether to one of suspend, resume, stop, start and restart one of a service, communication and data flow at the wireless device 22.

Example D4. The method of Example D1, further comprising implementing a configuration of the at least one threshold of the multi-level energy thresholds that is one of received from the network node 16 and pre-stored at the wireless device 22.

Example D3. The method of Example D1, wherein the reporting is one of a transmission state reporting, transmission state update reporting, energy warning reporting and data radio bearer, DRB, status.

Example D4. The method of Example D1, wherein one set of the multi-level energy thresholds includes at least one of:
a QoS-Flow enabling threshold;
a QoS-Flow disabling threshold;
a QoS-Flow enter enabling threshold;
a QoS-Flow enter disabling threshold;
a service enabling threshold;
a service disabling threshold;
a service enter enabling threshold;
a service enter disabling threshold;
a DRB flow enabling threshold;
a DRB flow disabling threshold;
a DRB flow enter enabling threshold;
a DRB flow enter disabling threshold;
a flow enabling threshold;
a flow disabling threshold;
a flow enter enabling threshold;
a flow enter disabling threshold;
a transmission enabling threshold;
a transmission enabling enter threshold;
a transmission enabling leave threshold;
a transmission disabling threshold;
a transmission disabling enter threshold;
a transmission disabling leave threshold;
an energy warning enter threshold; and
an energy warning leave threshold.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that May be Used in the Preceding Description Include:

### Abbreviation Explanation

3GPP 3rd Generation Partnership Project
BWP Bandwidth Part
C-RNTI Cell Radio Network Temporary Identifier
CG Configured Grant
CORESET Control Resource Set
CSS Common Search Space
DCI Downlink Control Information
DRB Data Radio Bearer or Dedicated Radio Bearer
eMBB enhanced Mobile Broadband
eRedCap Enhanced Reduced Capability NR Devices
IE Information Element
LPWA Low power wide area
LTE Long-Term Evolution
MAC-CE Media Access Control-Control Element
MICO Mobile Originated Communication Only
MIMO Multiple-Input and Multiple-Output
mMTC massive Machine-Type Communication
Msg1 Message 2 during random access
Msg2 Message 2 during random access
MTC Machine-Type Communications
NB-IoT Narrowband Internet of Things
NR New Radio
NW Network
RAI Release Assistance Information
RedCap Reduced Capability NR Devices
RRC Radio Resource Control
PDCCH Physical Downlink Control Channel
PUCCH Physical Uplink Control Channel
PUSCH Physical Uplink Shared Channel
RACH Random Access Channel
PRB Physical Resource Block
PSM
Power Saving Mode
Random Access Response
RAR
SDT Small Data Transmission
SCS Subcarrier Spacing
SI System information
SIB System information block
SRS Sounding Reference Signal
SSB Synchronization Signal Block
UAI UE Assistance Information
UCI Uplink Control information
UE User equipment
URLLC Ultra-Reliable Low-Latency Communication

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An energy harvesting wireless device configured to communicate with a network node, the energy harvesting wireless device comprising:
processing circuitry configured to:
determine a first energy level of the energy harvesting wireless device meets a first threshold of a set of multi-level energy thresholds; and
send to the network node a reporting indicating one of an enablement and disablement of a first communication configuration for a data flow of an application service based on the determination that the first threshold is met.

2.-12. (canceled)

13. A network node configured to communicate with an energy harvesting wireless device, the network node comprising:
processing circuitry configured to:
receive a reporting indicating at least a first threshold of a set of multi-level energy thresholds is met at the energy harvesting wireless device;
determine one of an enablement and disablement of a first communication configuration for a data flow of an application service at the energy harvesting wireless device based on the first threshold is met; and
perform communication with the energy harvesting wireless device based on the determination that the first threshold is met.

14.-19. (canceled)

20. A method implemented by an energy harvesting wireless device that is configured to communicate with a network node, the method comprising:
determining a first energy level of the energy harvesting wireless device meets a first threshold of a set of multi-level energy thresholds; and
sending to the network node a reporting indicating one of an enablement and disablement of a first communication configuration for a data flow of an application service based on the determination that the first threshold is met.

21. The method of claim 20, wherein the first communication configuration corresponds to:
a quality of service, QoS, flow state associated with whether data is allowed to be accepted by a data buffer; or
one of a quality of service, QoS, flow and data radio bearer, DRB; or
data transmission from the energy harvesting wireless device.

22.-23. (canceled)

24. The method of claim 20, wherein the first threshold is one of:
a quality of service, QoS, flow state enabling threshold;
QoS flow state disabling threshold;
QoS flow enabling threshold;
QoS flow disabling threshold;
transmission enabling threshold; and
transmission disabling threshold.

25. The method of claim 20, further comprising:
determining a second energy level of the energy harvesting wireless device meets a second threshold of the set of multi-level energy thresholds, the second threshold being different from the first threshold; and
sending to the network node a reporting indicating one of an enablement and disablement of a second communication configuration for the data flow of the application service based on the determination that the second threshold is met.

26. The method of claim 20, further comprising:
determining a first energy level of the energy harvesting wireless device meets a warning threshold of the set of multi-level energy thresholds; and
sending to the network node a reporting indicating one of an enablement and disablement of an energy warning indication based on the determination that the warning threshold is met.

27. The method of claim 20, wherein the energy harvesting wireless device is preconfigured with the set of multi-level energy thresholds.

28. The method of claim 20, further comprising:
receiving one of dynamic and semi-static signaling indicating the set of multi-level energy thresholds; and
monitoring the energy level of the energy harvesting wireless device using the set of multi-level energy thresholds.

29. The method of claim 20, wherein the reporting indicates at least one of
the set of multi-level energy thresholds are met;
a preference regarding at least one threshold of the multi-level energy thresholds; and
at least one of energy harvesting capability, harvesting pattern, and harvesting power per unit of time of the energy harvesting wireless device.

30. The method of claim 20, further comprising suspending a N3 tunnel based on the first communication configuration having been disabled for a predefined period of time.

31. The method of claim 30, further comprising resuming the N3 tunnel based on the re-enabling of the first communication configuration.

32. A method implemented by a network node that is configured to communicate with an energy harvesting wireless device, the method comprising:
receiving a reporting indicating at least a first threshold of a set of multi-level energy thresholds is met at the energy harvesting wireless device;
determining one of an enablement and disablement of a first communication configuration for a data flow of an application service at the energy harvesting wireless device based on the first threshold is met; and
performing communication with the energy harvesting wireless device based on the determination that the first threshold is met.

33. The method of claim 32, wherein the first communication configuration corresponds to a quality of service, QoS, flow state associated with whether data is allowed to be accepted by a data buffer of the energy harvesting wireless device.

34. The method of claim 32, wherein the first communication configuration corresponds to one of a quality of service, QoS, flow and data radio bearer, DRB.

35. The method of claim 32, wherein the first communication configuration corresponds to data transmission from the energy harvesting wireless device.

36. The method of claim 32, wherein the first threshold is one of:
a quality of service, QoS, flow state enabling threshold;
QoS flow state disabling threshold;
QoS flow enabling threshold;
QoS flow disabling threshold;
transmission enabling threshold; and
transmission disabling threshold.

37. The method of claim 32, further comprising:
receiving a reporting indicating a second threshold of the set of multi-level energy thresholds is met, the second threshold being different from the first threshold;
determining one of enablement and disablement of a second communication configuration for the data flow of the application service at the energy harvesting wireless device based on the second threshold being met; and
the communication with the energy harvesting wireless device being based on the determination that the second threshold is met.

38. The method of claim 32, further comprising:
causing transmission of one of dynamic and semi-static signaling indicating the set of multi-level energy thresholds for implementation by the energy harvesting wireless device.
